(19) United States
(12) Patent Application Publication
(10) Pub. No.: US 2025/0355081 A1
(43) Pub. Date: Nov. 20, 2025

(54) SENSING SYSTEM, RECEIVER, CONTROL CIRCUIT, SENSING METHOD, TRANSMISSION METHOD, AND RECEPTION METHOD

(71) Applicant: Mitsubishi Electric Corporation, Tokyo (JP)

(72) Inventors: Akinori TAIRA, Tokyo (JP); Kazuaki ISHIOKA, Tokyo (JP)

(73) Assignee: Mitsubishi Electric Corporation, Tokyo (JP)

(21) Appl. No.: 19/289,345

(22) Filed: Aug. 4, 2025

Related U.S. Application Data
(63) Continuation of application No. PCT/JP2023/004552, filed on Feb. 10, 2023.

(51) Int. Cl. G01S 7/35; G01S 7/03; G01S 13/90

(52) U.S. Cl. CPC G01S 7/352; G01S 7/03; G01S 13/90

(57) ABSTRACT

A sensing system includes: a transmitter including transmitting antenna elements, controlling timings of generations of a radar signal, a code, and a carrier signal for dividing a frequency band available into subbands and periodically switching the subbands, multiplying the radar signal and the code for each transmitting antenna element, generating a high frequency signal having a bandwidth of the subband using the radar signal multiplied by the code and the carrier signal, and transmitting the high frequency signal from each transmitting antenna element; and a receiver including receiving antenna elements, receiving the high frequency signals transmitted from the transmitter and reflected or scattered by a measurement target, generating channel information between the transmitter and the receiver using the carrier signal, the radar signal, and the code, specifying a position of the measurement target using the channel information, and generating an image of the measurement target by performing focus correction.

### CROSS-REFERENCE TO RELATED APPLICATION

This application is a continuation application of International Application PCT/JP2023/004552, filed on Feb. 10, 2023, and designating the U.S., the entire contents of which are incorporated herein by reference.

### BACKGROUND OF THE INVENTION

### 1. Field of the Invention

The present disclosure relates to a sensing system, a receiver, a control circuit, a sensing method, a transmission method, and a reception method, the sensing system measuring a measurement target using electromagnetic waves.

### 2. Description of the Related Art

In recent years, in addressing tasks such as advancement of automatic control of systems called digital twin or cyber-physical systems and realization of safe and secure society with a decrease in working population, there has been an increasing need for sensing technology for sensing the surrounding environment. For example, an in-vehicle radar for forward monitoring and side monitoring essential for automatic driving of a vehicle is an example related to such sensing technology. In addition, new applications based on the sensing technology, such as non-stop security gates for quality control and safety assurance in production lines, have emerged.

Conventionally, as means for collecting information on the surrounding environment from a distant position, a radar device utilizing electromagnetic waves has been used. For example, Japanese Patent Application Laid-open No. 2021-81282 discloses a technique of a multiple input multiple output (MIMO) radar device with improved performance of detecting a moving object. The radar device described in Japanese Patent Application Laid-open No. 2021-81282 acquires information on MIMO channels formed between a plurality of transmitting elements and a plurality of receiving elements, and measures a reflection point.

The conventional radar technology has been developed mainly for the purpose of detecting an aircraft, a vehicle, and the like, and thus focuses mainly on detecting a position and a relative traveling speed of the reflection point that is a certain distance away. Meanwhile, when considering new applications such as a security gate that requires detection of a metal object possessed by a pedestrian and determination of a shape thereof, that is, determination of a type and a level of danger of the metal object, and a non-destructive inspection that detects a crack, a cavity, and the like inside a plastic resin, these applications require high resolution at a position close to a sensor and multilayered spatial analysis performance in a depth direction.

In order to increase the resolution in the radar device, it is effective to use a shorter wavelength, that is, a higher frequency, and to increase the aperture diameter of an antenna. However, when considering a close-range sensing application, downsizing of the device is an important factor, and it is difficult to increase the size of the antenna. Since the aperture diameter of the antenna can be reduced in proportion to the wavelength, the utilization of a high frequency band is a necessary and effective solution.

The application such as the non-destructive inspection requires the resolution in the depth direction, that is, a distance direction. The so-called range resolution depends on a frequency bandwidth that can be used as a radar signal. However, a low frequency band is already used by another system, so that the utilization of the high frequency band is required to secure a wide band. Also, in the close-range sensing in which the aperture diameter cannot be ignored with respect to a measurement distance, that is, the aperture diameter cannot be regarded as a point, a function equivalent to focus adjustment based on the measurement distance is required. Moreover, in order to perform tomographic imaging such as computed tomography (CT) scanning implemented by X-rays on a measurement target, it is important to perform focus adjustment based on the position of each layer.

Thus, in order to obtain a three-dimensionally high-resolution sensing system, it is important to utilize a broadband signal, for which the use of the high frequency band is effective. However, there has been a problem that designing and manufacturing a high frequency circuit that processes a broadband signal exceeding 10 GHz in the high frequency band is very difficult and results in an increase in cost.

### SUMMARY OF THE INVENTION

In order to solve the above-described problems, a sensing system according to the present disclosure includes: a transmitter that includes a plurality of transmitting antenna elements to: control timings of generation of a radar signal, generation of a code for a receiver to separate high frequency signals transmitted from the plurality of the transmitting antenna elements into the high frequency signals transmitted from individual ones of the transmitting antenna elements, and generation of a carrier signal to divide a frequency band available into a plurality of subbands and periodically switch the subbands used for the high frequency signals transmitted from the plurality of the transmitting antenna elements so that an entire range of the frequency band is used; multiply the radar signal and the code for each of the plurality of the transmitting antenna elements; generate the high frequency signal having a bandwidth of the subband using the radar signal multiplied by the code and the carrier signal; and transmit the high frequency signal from each of the plurality of the transmitting antenna elements; and a receiver that includes a plurality of receiving antenna elements to: receive the high frequency signals transmitted from the transmitter and reflected or scattered by a measurement target; generate channel information indicating a state of a channel between the transmitter and the receiver using the carrier signal, the radar signal, and the code; specify a position of the measurement target using the channel information; and generate an image of the measurement target by performing focus correction on the measurement target.

### BRIEF DESCRIPTION OF THE DRAWINGS

FIG. 1 is a diagram illustrating a general idea of measurement intended to be performed by a sensing system according to a first embodiment;

FIG. 2 is a diagram illustrating an exemplary configuration of the sensing system according to the first embodiment;

FIG. 3 is a graph illustrating an example of high frequency signals transmitted from a transmitter according to the first embodiment;

FIG. 4 is a flowchart illustrating an operation of the sensing system according to the first embodiment;

FIG. 5 is a flowchart illustrating an operation of the transmitter according to the first embodiment;

FIG. 6 is a flowchart illustrating an operation of a receiver according to the first embodiment;

FIG. 7 is a diagram illustrating an exemplary configuration of processing circuitry in a case where the processing circuitry implementing the transmitter according to the first embodiment is implemented by a processor and a memory;

FIG. 8 is a diagram illustrating an example of processing circuitry in a case where the processing circuitry implementing the transmitter according to the first embodiment includes dedicated hardware;

FIG. 9 is a diagram illustrating a general idea of measurement intended to be performed by a sensing system according to a second embodiment;

FIG. 10 is a diagram illustrating an exemplary configuration of the sensing system according to the second embodiment;

FIG. 11 is a graph illustrating an example of high frequency signals transmitted from transmitters according to a third embodiment;

FIG. 12 is a diagram illustrating a general idea of measurement intended to be performed by a sensing system according to a fourth embodiment;

FIG. 13 is a graph illustrating an example of high frequency signals transmitted from a transmitter according to the fourth embodiment;

FIG. 14 is a diagram illustrating a concept of an operation of a layer clipping unit of a receiver according to a fifth embodiment; and

FIG. 15 is a diagram illustrating a concept of an operation of a focus correction unit of the receiver according to the fifth embodiment.

### DETAILED DESCRIPTION OF THE PREFERRED EMBODIMENTS

Hereinafter, a sensing system, a receiver, a control circuit, a sensing method, a transmission method, and a reception method according to embodiments of the present disclosure will be described in detail with reference to the drawings.

### First Embodiment

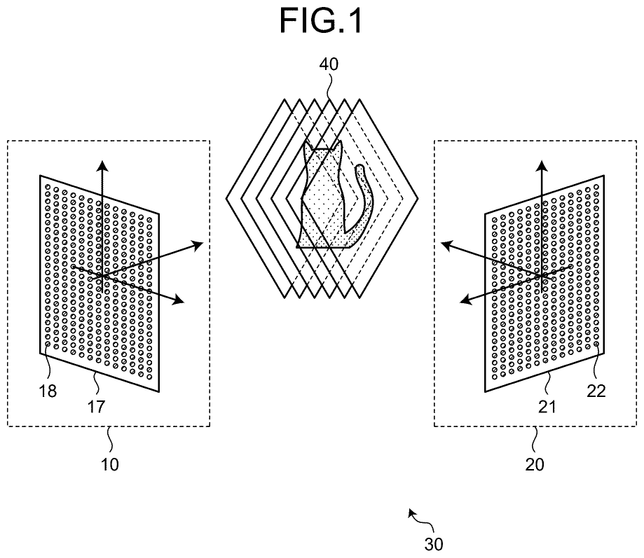

FIG. 1 is a diagram illustrating a general idea of measurement intended to be performed by a sensing system 30 according to a first embodiment. The sensing system 30 is a system that includes a transmitter 10 and a receiver 20 and measures a measurement target 40. In the sensing system 30, the transmitter 10 emits radio waves from a transmitting array 17 including a plurality of transmitting antenna elements 18 to the measurement target 40, and the receiver 20 receives reflected waves, scattered waves, and the like from the measurement target 40 by a receiving array 21 including a plurality of receiving antenna elements 22, whereby the measurement target 40 is measured. In the first embodiment, the transmitter 10 transmits high frequency signals as the emission of the radio waves. In the transmitter 10, the transmitting array 17 includes N_{T} pieces of the transmitting antenna elements 18 as the plurality of the transmitting antenna elements 18. In the receiver 20, the receiving array 21 includes N_{R} pieces of the receiving antenna elements 22 as the plurality of the receiving antenna elements 22. As will be described later, the sensing system 30 extracts information of the measurement target 40 from N_{T}×N_{R} or more pieces of channel information formed between the N_{T} pieces of the transmitting antenna elements 18 and the N_{R} pieces of the receiving antenna elements 22.

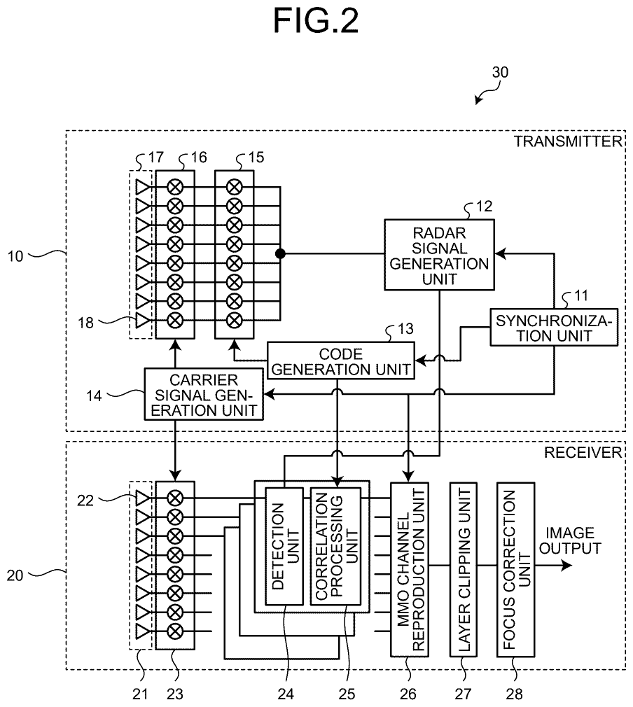

FIG. 2 is a diagram illustrating an exemplary configuration of the sensing system 30 according to the first embodiment. As described above, the sensing system 30 includes the transmitter 10 and the receiver 20. The transmitter 10 includes a synchronization unit 11, a radar signal generation unit 12, a code generation unit 13, a carrier signal generation unit 14, an encoding unit 15, a high frequency signal generation unit 16, and the transmitting array 17. As described above, the transmitting array 17 includes the N_{T} pieces of the transmitting antenna elements 18.

The synchronization unit 11 adjusts the timing of operation of each unit in the transmitter 10 and the receiver 20. The synchronization unit 11 controls the timings of generation of a radar signal by the radar signal generation unit 12, generation of a code by the code generation unit 13, and generation of a carrier signal by the carrier signal generation unit 14 in the transmitter 10. The radar signal generation unit 12 generates the radar signal at a baseband or intermediate frequency. The radar signal is a periodic broadband signal as described later. The code generation unit 13 generates the codes for the receiver 20 to separate the high frequency signals transmitted from the transmitting array 17 including the plurality of the transmitting antenna elements 18 into the high frequency signals transmitted from the transmitting antenna elements 18. The carrier signal generation unit 14 generates a reference carrier for generating a final high frequency signal. As will be described later, the carrier signal generation unit 14 generates the carrier signals to divide a frequency band available for use by the transmitter 10 into a plurality of subbands and periodically switch the subbands used for the high frequency signals transmitted from the plurality of the transmitting antenna elements 18 so that the entire frequency band is used.

The encoding unit 15 performs, for each of the plurality of the transmitting antenna elements 18, code multiplication in which the radar signal generated by the radar signal generation unit 12 is multiplied by the code generated by the code generation unit 13. For each of the transmitting antenna elements 18, the high frequency signal generation unit 16 generates the high frequency signal to be transmitted from the transmitting antenna element 18 using the signal obtained by multiplying the radar signal by the code in the encoding unit 15 and the reference carrier generated in the carrier signal generation unit 14. The high frequency signal generation unit 16 is, for example, an up-converter or a multiplier and generates the high frequency signal having a bandwidth of the subband by using the radar signal multiplied by the code and the carrier signal, to cause the high frequency signal to be transmitted from each of the plurality of the transmitting antenna elements 18. In the transmitting array 17, the transmitting antenna elements 18 transmit the high frequency signals generated by the high frequency signal generation unit 16.

The receiver 20 includes the receiving array 21, a signal conversion unit 23, a detection unit 24, a correlation processing unit 25, a MIMO channel reproduction unit 26, a layer clipping unit 27, and a focus correction unit 28. As described above, the receiving array 21 includes the N_{R} pieces of the receiving antenna elements 22.

In the receiving array 21, the receiving antenna elements 22 receive the high frequency signals transmitted from the transmitter 10, the high frequency signals being the reflected waves reflected by the measurement target 40 or the scattered waves scattered by the measurement target 40. That is, the receiving antenna elements 22 receive the reflected waves or the scattered waves of the high frequency signals transmitted from the transmitter 10. Note that the receiving antenna elements 22 can also directly receive the high frequency signals transmitted from the transmitter 10 depending on the positional relationship, orientation relationship, and the like between the transmitting antenna elements 18 of the transmitter 10 and the receiving antenna elements 22 of the receiver 20. For each of the receiving antenna elements 22, the signal conversion unit 23 converts the high frequency signals received by the receiving antenna element 22 into baseband or intermediate frequency signals, that is, down-converts the high frequency signals. The signal conversion unit 23 is, for example, a down converter and converts the high frequency signals received by the plurality of the receiving antenna elements 22 into received signals in the frequency band of the radar signals, which are used for the generation of the high frequency signals by the transmitter 10, by using the carrier signals used for the generation of the high frequency signals by the transmitter 10.

The detection unit 24 is disposed for each of the receiving antenna elements 22 and detects the baseband or intermediate frequency received signals, which are obtained after conversion by the signal conversion unit 23, using the radar signals generated by the radar signal generation unit 12 of the transmitter 10, thereby obtaining received information. The received information is the reflected waves or the scattered waves of the high frequency signals received by the receiving antenna elements 22 and includes the high frequency signals transmitted from the plurality of the transmitting antenna elements 18. Note that the receiver 20 may obtain the received information by mixing, with a mixer, the baseband or intermediate frequency received signals obtained after conversion by the signal conversion unit 23. Hereinafter, a case where the detection unit 24 performs the detection will be described. The correlation processing unit 25 is disposed for each of the receiving antenna elements 22 and performs correlation processing on the received information, which is detected by the detection unit 24, using the codes generated by the code generation unit 13 of the transmitter 10, thereby separating the received information into the signals from the transmitting antenna elements 18 of the transmitter 10, that is, separating the received signals received by the plurality of the receiving antenna elements 22 into the individual signals of the transmitting antenna elements 18 transmitted from the transmitter 10 for each of the receiving antenna elements 22.

The MIMO channel reproduction unit 26 reproduces a state of the channels between the transmitter 10 and the receiver 20 by using the signals separated for the individual transmitting antenna elements 18 for each of the receiving antenna elements 22 by the correlation processing unit 25, and generates MIMO channel information indicating the state of the channels. The MIMO channel reproduction unit 26 generates the MIMO channel information for each frequency bin to be described later. In the following description, the MIMO channel reproduction unit may be simply referred to as a channel reproduction unit, and the MIMO channel information may be simply referred to as channel information. The layer clipping unit 27 specifies the position of the measurement target 40 using the MIMO channel information. The layer clipping unit 27 clips the measurement target 40 by a specific curved surface from the MIMO channel information reproduced by the MIMO channel reproduction unit 26. Specifically, the layer clipping unit 27 specifies the position of the measurement target 40 by extracting, from the MIMO channel information, reflection point information of a layer corresponding to a distance in a depth direction of the measurement target 40 as viewed from the plurality of the receiving antenna elements 22. The focus correction unit 28 performs focus correction on the measurement target 40 whose position has been specified, and generates and outputs an image that is image information of the measurement target 40. As the focus correction on the measurement target 40, the focus correction unit 28 performs focus correction corresponding to the position of the layer on the reflection point information extracted.

The operation of the sensing system 30 will be described. In the transmitter 10, the synchronization unit 11 controls, on the basis of a frame configuration described later, a timing of radar signal generation by the radar signal generation unit 12, a timing of code generation by the code generation unit 13, and a timing of carrier frequency switching by the carrier signal generation unit 14.

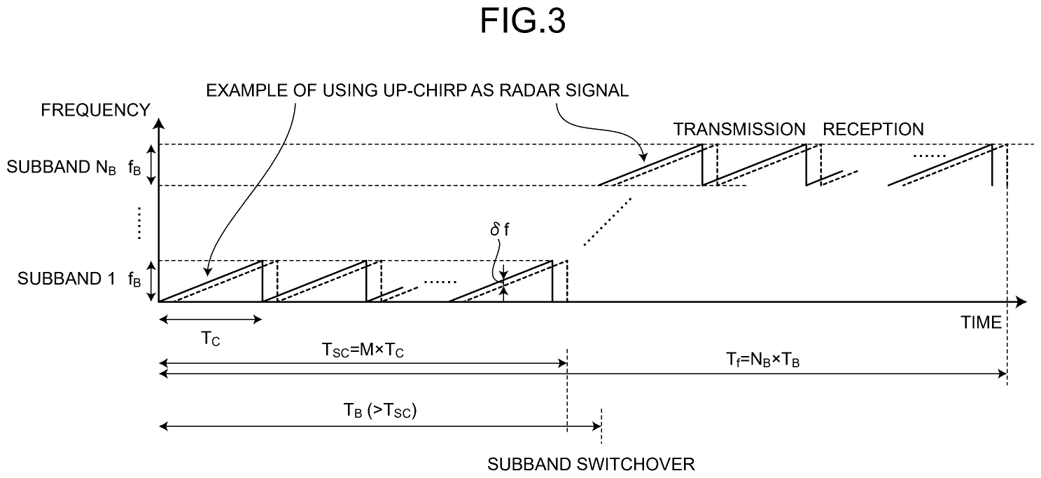

FIG. 3 is a graph illustrating an example of the high frequency signals transmitted from the transmitter 10 according to the first embodiment. FIG. 3 illustrates the example in which an up-chirp is used as the radar signal generated by the radar signal generation unit 12, but the radar signal is not limited to the up-chirp and need only be a signal with the spectrum spreading over an entire specific frequency band, the signal including an up-down chirp, a Zadoff-Chu (ZC) sequence, a pseudo noise (hereinafter referred to as PN) signal, an orthogonal frequency division multiplexing (OFDM) signal, a frequency step signal that is a signal whose frequency changes stepwise in a time direction, a general spread signal, and the like. The frequency band available to the sensing system 30 is divided into partial N_{B} bands having a bandwidth f_{B}. In FIG. 3, the bands are indicated by subband 1 to subband N_{B}. These bands, that is, the subband 1 to the subband N_{B} may partially overlap each other.

The radar signal generation unit 12 generates, as the radar signal, a periodic broadband signal represented by a chirp signal in each subband. At this time, the synchronization unit 11 instructs the radar signal generation unit 12 on a timing of the beginning of each period. The period of the broadband signal is set to be 1/A of a chip period T_{C}, where “A” is an integer. That is, the code generation unit 13 generates the code such that the chip period T_{C} of the code is an integer multiple of the period of the radar signal. FIG. 3 illustrates an example when A=1. The code generation unit 13 generates the code having a code length of M chips to be used by each of the transmitting antenna elements 18. As illustrated in FIG. 3, the code period is T_{SC}=M×T_{C}. At this time, the synchronization unit 11 instructs the code generation unit 13 on a timing of the beginning of the code period. The encoding unit 15 performs code multiplication in which the radar signal generated by the radar signal generation unit 12 is multiplied by the code generated by the code generation unit 13. The code is generally expressed as ±1. The encoding unit 15 performs the multiplication processing as phase modulation, amplitude modulation, frequency modulation, or a combination thereof.

The transmitter 10 transmits the radar signal for at least the code period T_{SC} in each subband, but may transmit the radar signal for a duration equal to or longer than the code period T_{SC}, such as for a time period of “T_{B}” illustrated in FIG. 3, by repeatedly using the code. The time period of “T_{B}” illustrated in FIG. 3 is a subband switching period.

After completing the transmission of the radar signal for the subband switching period T_{B} in one subband, the transmitter 10 switches the frequency, that is, switches the subband. The carrier signal generation unit 14 generates the carrier signal for converting the radar signal encoded by the encoding unit 15 into the high frequency signal in each subband. The carrier signal generation unit 14 receives an instruction from the synchronization unit 11 and generates an appropriate carrier signal to switch the subband every subband switching period T_{B}. The high frequency signal generation unit 16 converts the radar signal encoded by the encoding unit 15 into the high frequency signal in each subband by using the carrier signal generated by the carrier signal generation unit 14, and transmits the high frequency signal from the transmitting antenna element 18 of the transmitting array 17. A period in which the transmitter 10 transmits the radar signal from the subband 1 to the subband N_{B}, that is, over the entire frequency band of the N_{B} subbands is defined as a frame period T_{f}=N_{B}×T_{B}. Assuming that the high frequency signals in the subband 1 to the subband N_{B} illustrated in FIG. 3 correspond to one frame, the transmitter 10 completes one measurement by transmission of one frame, that is, in one frame period T_{f}.

Note that the codes generated by the code generation unit 13 are used to identify the signals between the transmitting antenna elements 18. Therefore, the code generation unit 13 generates what is called orthogonal codes or quasi-orthogonal codes having a small cross-correlation between the transmitting antenna elements 18. Note that, as the code generated by the code generation unit 13 and used for the identification between the transmitting antenna elements 18, an M sequence, a Gold code, a Walsh-Hadamard code, a PN sequence, and the like are known, but the code is not limited thereto as long as the code has high orthogonality.

In the sensing system 30, the transmitter 10 and the receiver 20 are synchronized in time and frequency, and operate according to the same instruction from the synchronization unit 11. Note that the sensing system 30 may have a bistatic configuration in which the transmitter 10 and the receiver 20 are disposed at physically separated positions. In this case, the transmitter 10 and the receiver 20 can be synchronized using not only a wired connection but also a global positioning system (GPS), various wireless links, and the like. For example, the sensing system 30 may be in a mode in which the carrier signal generation unit 14 is disposed independently of the transmitter 10 and the receiver 20, and a base signal and a reference signal for matching frequencies are shared by the transmitter 10 and the receiver 20. Here, as illustrated in FIG. 2, the configuration in which the functional units of the transmitter 10 and the receiver 20 are connected by wire is used as an example to describe operations of the transmitter 10 and the receiver 20.

In the receiver 20, the high frequency signals emitted from the transmitter 10 to the measurement target 40 and reflected or scattered by the measurement target 40 are received by the receiving antenna elements 22 of the receiving array 21. The signal conversion unit 23 uses the carrier signal corresponding to each subband generated by the carrier signal generation unit 14 to convert the high frequency signals received by the receiving antenna elements 22 of the receiving array 21 into the baseband or intermediate frequency signals, that is, down-convert the high frequency signals. The detection unit 24 is disposed for each of the receiving antenna elements 22 and detects the baseband or intermediate frequency signals, which are obtained after conversion by the signal conversion unit 23, using the radar signals generated by the radar signal generation unit 12 of the transmitter 10, thereby obtaining the received information. The received information includes the signals transmitted from all the N_{T} pieces of the transmitting antenna elements 18 in a way that the signals are received by a specific one of the receiving antenna elements 22.

The correlation processing unit 25 uses the codes generated by the code generation unit 13 of the transmitter 10 to perform correlation processing on the received information obtained by detection by the detection unit 24, thereby separating the received information into the signals from the transmitting antenna elements 18 of the transmitter 10. In the receiver 20, the processing of the correlation processing unit 25 is performed for each of the receiving antenna elements 22, so that N_{T}×N_{R} pieces of the channel information of each subband are obtained. Note that the detection processing in the detection unit 24 differs depending on what kind of signal is used as the radar signal, and thus detailed description thereof is omitted here. In the first embodiment, the detection processing in the detection unit 24 may be a versatile processing method.

How wide the bandwidth f_{B} of the subband is set depends on the frequency band used by the sensing system 30, various architectures thereof, and the like. In particular, in a case where the sensing system 30 uses an ultrahigh frequency band such as a terahertz band, there is a high possibility that a large fluctuation in frequency characteristics occurs in the band of the subband. Therefore, the sensing system 30 may divide the bandwidth f_{B} of the subband into a plurality of frequency bins and calculate the channel information. Generally, the frequency bin is set to a bandwidth in which a frequency fluctuation in the band is considered to be constant. In the receiver 20, the MIMO channel reproduction unit 26 divides each subband into N_{F} frequency bins, and calculates the channel information formed between the transmitting array 17 of the transmitter 10 and the receiving array 21 of the receiver 20 with the measurement target 40 sandwiched therebetween as illustrated in FIG. 1. As a result, the MIMO channel reproduction unit 26 can integrate the information of all the subbands to obtain the MIMO channel information including N_{T}×N_{R}×N_{F}×N_{B} elements. In the following description, the frequency bin may be referred to as a frequency bin.

As described above, the transmitter 10 transmits the high frequency signals by dividing the frequency band available into the plurality of the subbands and periodically switching the subbands used for the high frequency signals transmitted from the plurality of the transmitting antenna elements 18 so that the entire frequency band is used. At this time, as the MIMO channel information, the MIMO channel reproduction unit 26 generates the MIMO channel information, the number of which is equal to a number obtained by multiplying the number of the plurality of the transmitting antenna elements 18 included in the transmitter 10, the number of the plurality of the receiving antenna elements 22 included in the receiver 20, the number of the subbands, and the number of the frequency bins obtained when the bandwidth of the subband is divided into the plurality of the frequency bins.

Note that in order to spatially generate N_{T}×N_{R} pieces of the MIMO channel information, here, the technique of using N_{T}×N_{R} pieces of the real antenna elements has been described. On the other hand, using an approximation technique, that is, interpolation, extrapolation, or the like can also generate N_{T}×N_{R} pieces of the MIMO channel information while reducing the number of the real antenna elements. Such processing itself is a general technique, and thus detailed description thereof is omitted here.

As with the detection processing, different techniques are used for the generation of the MIMO channel information depending on the type of the radar signal, the detection method, and the like, and thus the technique of generating the MIMO channel information is not limited here. For example, in a case where the chirp signal as illustrated in FIG. 3 is used as the radar signal, the receiver 20 obtains the carrier signal having a frequency difference δf corresponding to a distance to the reflection point after the detection. In a case where there is a plurality of the reflection points, the carrier signals having a plurality of frequencies are superimposed. From this information, the receiver 20 calculates a phase, amplitude characteristics, and the like of each frequency bin.

The MIMO channel information obtained includes all the reflection point information of the measurement target 40. The layer clipping unit 27 clips only the reflection point information on a specific curved surface determined from the placement of the transmitting antenna elements 18 and the receiving antenna elements 22. Note that the specific curved surface may be a specific flat surface. The focus correction unit 28 can obtain a tomographic image of a given portion of the measurement target 40 by focusing on the curved surface. Note that the processing of the layer clipping unit 27 and the processing of the focus correction unit 28 are performed in no particular order. Also, in a case where the measurement target 40 is made of a non-transmissive material so that the main reflection point is only on a surface of the target, the layer clipping processing of the layer clipping unit 27 can be omitted.

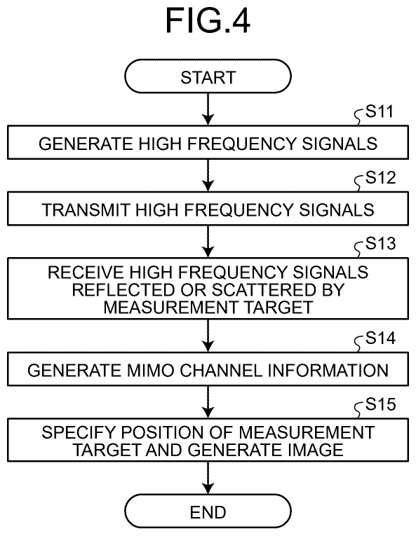

FIG. 4 is a flowchart illustrating the operation of the sensing system 30 according to the first embodiment. In the sensing system 30, the transmitter 10 generates the high frequency signals (step S11) and transmits the high frequency signals from the transmitting array 17 toward the measurement target 40 (step S12). The receiver 20 receives the high frequency signals transmitted from the transmitter 10 and reflected or scattered by the measurement target 40 (step S13), generates the MIMO channel information indicating the state of the channels between the transmitter 10 and the receiver 20 using the carrier signals, the radar signals, and the codes (step S14), and specifies the position of the measurement target 40 using the MIMO channel information to generate the image of the measurement target 40 by performing focus correction on the measurement target 40 (step S15).

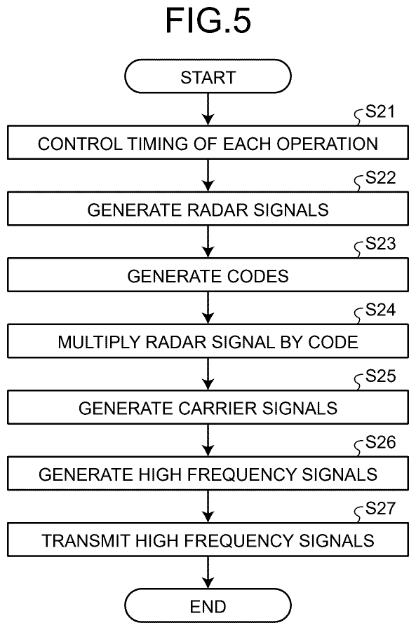

FIG. 5 is a flowchart illustrating the operation of the transmitter 10 according to the first embodiment. The flowchart illustrated in FIG. 5 illustrates details of the operations in step S11 and step S12 of the flowchart illustrated in FIG. 4. In the transmitter 10, the synchronization unit 11 controls the timings of the generation of the radar signal in the radar signal generation unit 12, the generation of the code in the code generation unit 13, and the generation of the carrier signal in the carrier signal generation unit 14, that is, controls the timing of each operation (step S21). The radar signal generation unit 12 under the control of the synchronization unit 11 generates the radar signals as the broadband signals (step S22). The code generation unit 13 under the control of the synchronization unit 11 generates the codes for the receiver 20 to separate the high frequency signals transmitted from the plurality of the transmitting antenna elements 18 into the high frequency signals transmitted from the individual transmitting antenna elements 18 (step S23). The encoding unit 15 multiplies the radar signal by the code for each of the plurality of the transmitting antenna elements 18 (step S24). The carrier signal generation unit 14 under the control of the synchronization unit 11 generates the carrier signals to divide the frequency band available for use by the transmitter 10 into the plurality of the subbands and periodically switch the subbands used for the high frequency signals transmitted from the plurality of the transmitting antenna elements 18 so that the entire frequency band is used (step S25). The high frequency signal generation unit 16 generates the high frequency signal having the bandwidth of the subband by using the radar signal multiplied by the code and the carrier signal (step S26). The plurality of the transmitting antenna elements 18 transmits the high frequency signals (step S27).

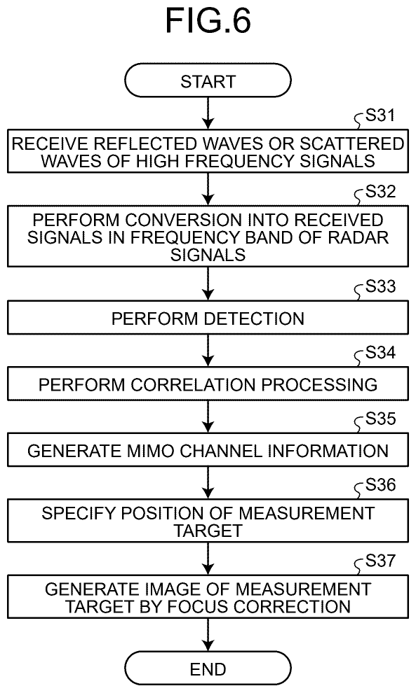

FIG. 6 is a flowchart illustrating the operation of the receiver 20 according to the first embodiment. The flowchart illustrated in FIG. 6 illustrates details of the operations from step S13 to step S15 of the flowchart illustrated in FIG. 4. In the receiver 20, the plurality of the receiving antenna elements 22 receives the reflected waves or the scattered waves of the high frequency signals transmitted from the transmitter 10, which includes the plurality of the transmitting antenna elements 18, and reflected or scattered by the measurement target 40 (step S31). The signal conversion unit 23 converts the reflected waves or the scattered waves of the high frequency signals received by the plurality of the receiving antenna elements 22 into the received signals in the frequency band of the radar signals, which are used for the generation of the high frequency signals by the transmitter 10, by using the carrier signals used for the generation of the high frequency signals by the transmitter 10 (step S32). The detection unit 24 detects the received signals using the radar signals generated by the transmitter 10, and obtains the received information that is the reflected waves or the scattered waves of the high frequency signals received by the receiving antenna elements 22 and includes the high frequency signals transmitted from the plurality of the transmitting antenna elements 18 (step S33). The correlation processing unit 25 performs the correlation processing on the received information by using the codes used when the radar signals are encoded by the transmitter 10, and separates the received signals into the individual signals of the transmitting antenna elements 18 transmitted from the transmitter 10 for each of the receiving antenna elements 22 (step S34). The MIMO channel reproduction unit 26 uses the separated signals to generate the MIMO channel information indicating the state of the channels between the transmitter 10 and the receiver 20 (step S35). The layer clipping unit 27 specifies the position of the measurement target 40 using the MIMO channel information (step S36). The focus correction unit 28 performs focus correction on the measurement target 40 whose position has been specified, and generates the image of the measurement target 40 (step S37).

Next, a hardware configuration of each device in the sensing system 30 will be described. In the transmitter 10, the transmitting array 17 includes the plurality of the transmitting antenna elements 18. The synchronization unit 11, the radar signal generation unit 12, the code generation unit 13, the carrier signal generation unit 14, the encoding unit 15, and the high frequency signal generation unit 16 are implemented by processing circuitry. The processing circuitry may include a memory and a processor that executes a program stored in the memory, or may include dedicated hardware. The processing circuitry is also called a control circuit.

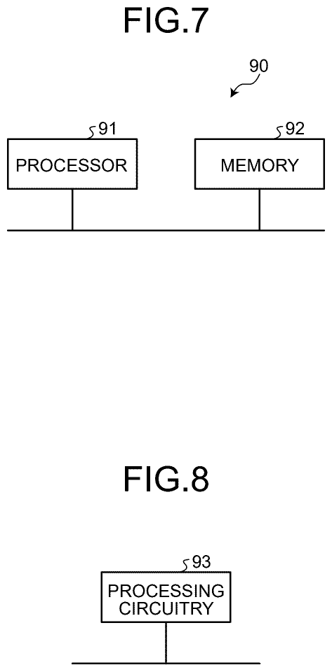

FIG. 7 is a diagram illustrating an exemplary configuration of processing circuitry 90 in a case where the processing circuitry implementing the transmitter 10 according to the first embodiment is implemented by a processor 91 and a memory 92. The processing circuitry 90 illustrated in FIG. 7 is the control circuit and includes the processor 91 and the memory 92. In the case where the processing circuitry 90 incudes the processor 91 and the memory 92, the functions of the processing circuitry 90 are implemented by software, firmware, or a combination of software and firmware. The software or firmware is described as the program and stored in the memory 92. The processing circuitry 90 implements the functions by the processor 91 reading and executing the program stored in the memory 92. That is, the processing circuitry 90 includes the memory 92 for storing the program, the execution of which results in the execution of the processing of the transmitter 10. It can also be said that this program is a program for causing the transmitter 10 to execute the functions implemented by the processing circuitry 90. This program may be provided by a storage medium storing the program, or may be provided by other means such as a communication medium.

The above program can also be said to be a program that causes the transmitter 10 to execute: a radar signal generating step in which the radar signal generation unit 12 generates the radar signals as the broadband signals; a code generating step in which the code generation unit 13 generates the codes for the receiver 20 to separate the high frequency signals transmitted from the plurality of the transmitting antenna elements 18 into the individual high frequency signals transmitted from the transmitting antenna elements 18; an encoding step in which the encoding unit 15 multiplies the radar signal by the code for each of the plurality of the transmitting antenna elements 18; a carrier signal generating step in which the carrier signal generation unit 14 generates the carrier signals to divide the frequency band available for use by the transmitter 10 into the plurality of the subbands and periodically switch the subbands used for the high frequency signals transmitted from the plurality of the transmitting antenna elements 18 so that the entire frequency band is used; a high frequency signal generating step in which the high frequency signal generation unit 16 generates the high frequency signal having the bandwidth of the subband by using the radar signal multiplied by the code and the carrier signal, and causes the high frequency signal to be transmitted from each of the plurality of the transmitting antenna elements 18; and a synchronizing step in which the synchronization unit 11 controls the timings of the generation of the radar signals, the generation of the codes, and the generation of the carrier signals.

Here, the processor 91 is, for example, a central processing unit (CPU), a processing unit, an arithmetic unit, a microprocessor, a microcomputer, a digital signal processor (DSP), or the like. The memory 92 corresponds to, for example, a non-volatile or volatile semiconductor memory such as a random access memory (RAM), a read only memory (ROM), a flash memory, an erasable programmable ROM (EPROM), or an electrically EPROM (EEPROM (registered trademark)), a magnetic disk, a flexible disk, an optical disk, a compact disc, a mini disc, a digital versatile disc (DVD), or the like.

FIG. 8 is a diagram illustrating an example of processing circuitry 93 in a case where the processing circuitry implementing the transmitter 10 according to the first embodiment includes the dedicated hardware. The processing circuitry 93 illustrated in FIG. 8 corresponds to, for example, a single circuit, a complex circuit, a programmed processor, a parallel-programmed processor, an application specific integrated circuit (ASIC), a field programmable gate array (FPGA), or a combination thereof. The processing circuitry may be implemented partly by dedicated hardware and partly by software or firmware. The processing circuitry can thus implement the functions described above by the dedicated hardware, the software, the firmware, or a combination thereof.

While the hardware configuration of the transmitter 10 has been described, the receiver 20 has a similar hardware configuration. In the receiver 20, the receiving array 21 includes the plurality of the receiving antenna elements 22. The signal conversion unit 23, the detection unit 24, the correlation processing unit 25, the MIMO channel reproduction unit 26, the layer clipping unit 27, and the focus correction unit 28 are implemented by processing circuitry. The processing circuitry may include a memory and a processor that executes a program stored in the memory, or may include dedicated hardware. The processing circuitry is also called a control circuit.

As described above, according to the present embodiment, in the sensing system 30, the transmitter 10 controls the timings of the generation of the radar signals, the generation of the codes, and the generation of the carrier signals, generates the high frequency signals having the bandwidth of the subband, and transmits the high frequency signals from the plurality of the transmitting antenna elements 18. The receiver 20 receives the high frequency signals transmitted from the transmitter 10 and reflected or scattered by the measurement target 40, generates the MIMO channel information using the carrier signals, the radar signals, and the codes generated by the transmitter 10, and specifies the position of the measurement target 40. As a result, the sensing system 30 can improve the resolution at low cost while using the high frequency signals when measuring the measurement target 40 that is close by. The sensing system 30 can acquire information of reflection and scattering in a wide frequency band necessary for performing high-resolution imaging, and perform imaging or tomographic imaging at a desired distance.

### Second Embodiment

A second embodiment will describe a case where a sensing system includes a plurality of transmitters and a plurality of receivers.

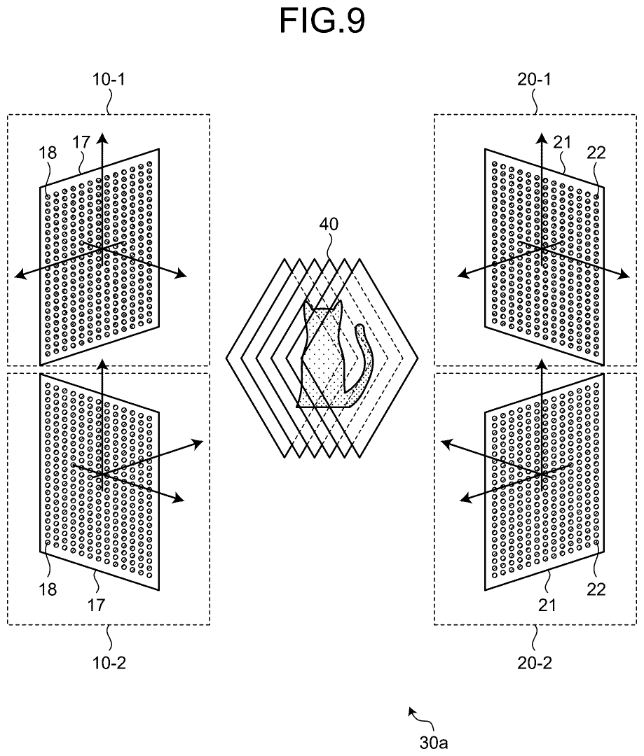

FIG. 9 is a diagram illustrating a general idea of measurement intended to be performed by a sensing system 30a according to the second embodiment. The sensing system 30a is a system that includes a plurality of the transmitters 10 and a plurality of the receivers 20 and measures the measurement target 40. That is, in the second embodiment, the plurality of the transmitters 10 and the plurality of the receivers 20 constitute the sensing system 30a. In FIG. 9, the plurality of the transmitters 10 is represented as transmitters 10-1 and 10-2, and the plurality of the receivers 20 is represented as receivers 20-1 and 20-2, but the numbers of the plurality of the transmitters 10 and the plurality of the receivers 20 may be three or more. The sensing system 30a is a system in which a plurality of sets of the transmitters 10 and the receivers 20 is located nearby, and the plurality of the transmitters 10 performs sensing by emitting radio waves at the same time. In the second embodiment, the transmitting arrays 17 of the plurality of the transmitters 10 operate nearby, so that a mechanism for suppressing interference between the transmitting arrays 17 is required.

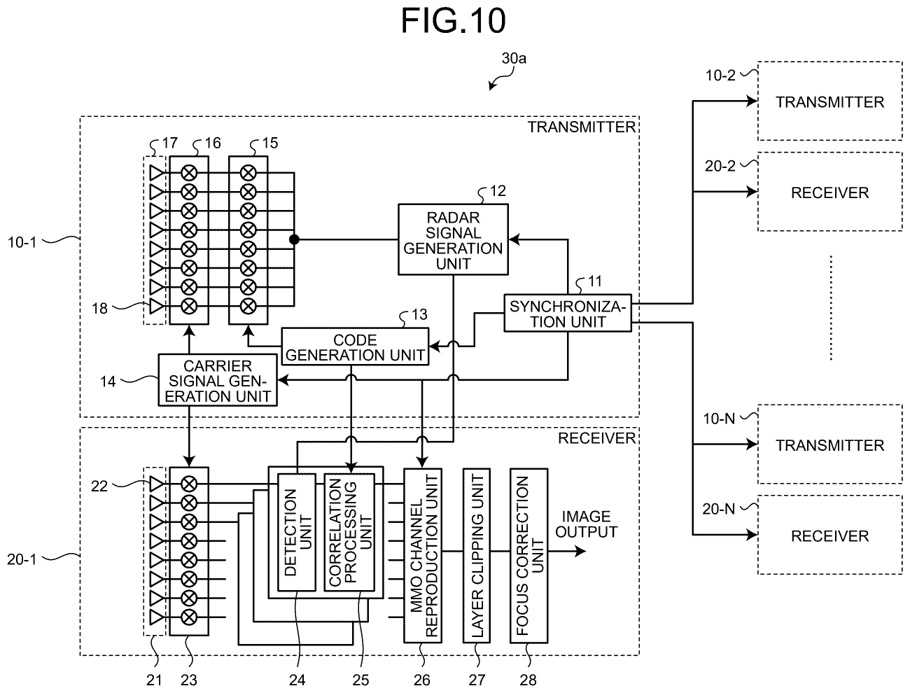

FIG. 10 is a diagram illustrating an exemplary configuration of the sensing system 30a according to the second embodiment. In the example of FIG. 10, the sensing system 30a includes the transmitter 10-1 to a transmitter 10-N as N pieces of the transmitters 10, and the receiver 20-1 to a receiver 20-N as N pieces of the receivers 20. Configurations of the transmitter 10-1 and the receiver 20-1 illustrated in FIG. 10 are similar to the configurations of the transmitter 10 and the receiver 20 illustrated in FIG. 2, respectively. However, the synchronization unit 11 of the transmitter 10-1 also instructs the other transmitters 10-2 to 10-N and receivers 20-2 to 20-N that operate simultaneously on the timing of operation of each component. In the following description, the transmitters 10-1 to 10-N may be referred to as the transmitters 10 when not distinguished from each other, and the receivers 20-1 to 20-N may be referred to as the receivers 20 when not distinguished from each other.

The transmitters 10-2 to 10-N may each have a configuration similar to the configuration of the transmitter 10-1, or have a configuration obtained by removing the synchronization unit 11 from the transmitter 10-1. In the case where the transmitters 10-2 to 10-N each have the configuration similar to the configuration of the transmitter 10-1, for example, the synchronization unit 11 of the transmitter 10-1 serves as a master, and the synchronization unit 11 of each of the transmitters 10-2 to 10-N serves as a slave so that the synchronization unit 11 of the transmitter 10-1 instructs the synchronization unit 11 of each of the transmitters 10-2 to 10-N on the timing of operation of each component. As a result, on the basis of the instruction from the synchronization unit 11 of the transmitter 10-1, the synchronization unit 11 of each of the transmitters 10-2 to 10-N can instruct each component therein on the timing of operation. In the case where the transmitters 10-2 to 10-N each have the configuration obtained by removing the synchronization unit 11 from the transmitter 10-1, the synchronization unit 11 of the transmitter 10-1 directly instructs each component in the transmitters 10-2 to 10-N on the timing of operation. The following description will be given using, as an example, the case where the transmitters 10-2 to 10-N each have the configuration obtained by removing the synchronization unit 11 from the transmitter 10-1, that is, a case where the transmitters 10-2 to 10-N each do not include the synchronization unit 11. Note that the receivers 20-2 to 20-N each have a configuration similar to the configuration of the receiver 20-1.

The operation of the sensing system 30a will be described. The operation of the transmitter 10-1 and the operation of the receiver 20-1 are similar to the operation of the transmitter 10 and the operation of the receiver 20 in the first embodiment, respectively. The transmitter 10-K receives the instruction from the synchronization unit 11 of the transmitter 10-1, and operates the radar signal generation unit 12 and the code generation unit 13 of the transmitter 10-K at the same timing as the timing at which the transmitter 10-1 operates the radar signal generation unit 12 and the code generation unit 13 of the transmitter 10-1. Note that “K” is an integer satisfying 2≤K≤N. At this time, the code generation unit 13 of the transmitter 10-K generates a code having a small correlation among the transmitters 10-1 to 10-N. Examples of the code generated by the code generation unit 13 of the transmitter 10-K include an M sequence, a Gold code, a Walsh-Hadamard code, a PN sequence, and the like, but the code is not limited thereto as long as the code has high orthogonality. In the sensing system 30a, the carrier signal generation units 14 and the high frequency signal generation units 16 in the transmitters 10-1 to 10-N perform the same operation in all the transmitters 10-1 to 10-N and switch the carrier frequency at the same timing.

As described above, the radar signal generation units 12, the code generation units 13, and the carrier signal generation units 14 in the plurality of the transmitters 10-1 to 10-N operate in synchronization. Moreover, the code generation units 13 in the plurality of the transmitters 10-1 to 10-N generate the codes having a low correlation among the plurality of the transmitters 10-1 to 10-N. The code generation units 13 in the plurality of the transmitters 10-1 to 10-N generate orthogonal codes or quasi-orthogonal codes as the codes having a low correlation among the plurality of the transmitters 10-1 to 10-N. That is, the plurality of the transmitters 10-1 to 10-N operates in synchronization with one another in terms of the generation of the radar signals, the generation of the codes, and the generation of the carrier signals, and generates the codes having a low correlation among the plurality of the transmitters 10-1 to 10-N.

The operation of each of the receivers 20-2 to 20-N is also similar to the operation of the receiver 20-1, that is, the receiver 20 of the first embodiment. The correlation processing unit 25 of the receiver 20-K performs correlation processing using the code used in the transmitter 10-K to extract only the signal from the transmitter 10-K while suppressing the signals from the other transmitters 10, thereby being able to generate the MIMO channel information. Thus, the correlation processing unit 25 of each of the plurality of the receivers 20-1 to 20-N performs correlation processing using the code used in the corresponding one of the transmitters 10.

Note that the second embodiment has been described assuming that the number of the transmitters 10 and the number of the receivers 20 are the same, but in the sensing system 30a, the number of the transmitters 10 and the number of the receivers 20 do not necessarily have to be the same. For example, in a case where the transmitters 10-1 and 10-2 as two transmitters 10 and a receiver 20-A as one receiver 20 are operated, the receiver 20-A can generate the MIMO channel information corresponding to two directions by the correlation processing unit 25 collectively using the codes used in the transmitters 10-1 and 10-2, and can generate and output an image corresponding to the two directions. Also, in a case where a transmitter 10-A as one transmitter 10 and the receivers 20-1 and 20-2 as two receivers 20 are operated, the receivers 20-1 and 20-2 both use the code used in the transmitter 10-A to be able to obtain images corresponding to their respective positional relationships.

As described above, according to the present embodiment, in the sensing system 30a, the plurality of the transmitters 10-1 to 10-N simultaneously transmits the high frequency signals, and the plurality of the receivers 20-1 to 20-N performs measurement and imaging in parallel. As a result, the sensing system 30a can implement imaging from a plurality of directions faster.

### Third Embodiment

A third embodiment will specifically describe the high frequency signals transmitted from the plurality of the transmitters 10 described in the second embodiment. Note that the sensing system 30a, the transmitters 10-1 to 10-N, and the receivers 20-1 to 20-N of the third embodiment have configurations similar to the configurations of the sensing system 30a, the transmitters 10-1 to 10-N, and the receivers 20-1 to 20-N of the second embodiment.

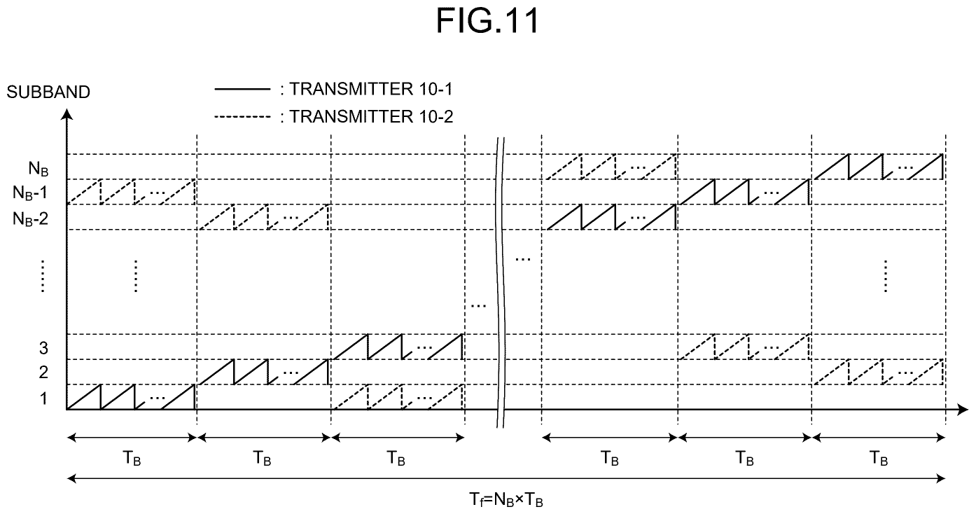

The operation of the sensing system 30a of the third embodiment will be described. FIG. 11 is a graph illustrating an example of the high frequency signals transmitted from the transmitters 10-1 and 10-2 according to the third embodiment. In the third embodiment, the operations of the transmitter 10-1 and the receiver 20-1 are similar to the operations of the transmitter 10-1 and the receiver 20-1 of the second embodiment, that is, the operations of the transmitter 10 and the receiver 20 of the first embodiment, respectively. However, the code generation unit 13 may generate the same code in the plurality of the transmitters 10. The transmitter 10-2 receives an instruction from the synchronization unit 11 of the transmitter 10-1, and operates the radar signal generation unit 12, the code generation unit 13, and the carrier signal generation unit 14 of the transmitter 10-2 at the same timing as the radar signal generation unit 12, the code generation unit 13, and the carrier signal generation unit 14 of the transmitter 10-1. At this time, the transmitters 10-1 and 10-2 need to avoid mutual interference. Therefore, the carrier signal generation unit 14 of the transmitter 10-2 uses a frequency hopping pattern different from that of the carrier signal generation unit 14 of the transmitter 10-1. FIG. 11 illustrates the example in which the transmitters 10-1 and 10-2 simultaneously transmit the high frequency signals. As indicated by solid lines, the transmitter 10-1 transmits the high frequency signals while switching the subband every subband switching period T_{B} in the order of subband 1, subband 2, subband 3, and so on. Meanwhile, as indicated by broken lines, the transmitter 10-2 transmits the high frequency signals while switching the subband every subband switching period T_{B} in the order of subband N_{B}-1, subband N_{B}-2, subband 1, and so on in a subband selection pattern, that is, the frequency hopping pattern different from that of the transmitter 10-1.

As described above, the carrier signal generation units 14 of the plurality of the transmitters 10-1 to 10-N generate the carrier signals in the different subbands at the same time among the plurality of the transmitters 10-1 to 10-N. Alternatively, the carrier signal generation units 14 of the plurality of the transmitters 10-1 to 10-N generate the carrier signals in the frequency hopping patterns that are different among the plurality of the transmitters 10-1 to 10-N.

The receivers 20-1 and 20-2 receive the high frequency signals using the frequency hopping patterns of the transmitters 10-1 and 10-2 with which the receivers 20-1 and 20-2 are paired, thereby being able to acquire the reflected waves or the scattered waves from the transmitters 10 desired. In general, the frequency hopping patterns that do not completely overlap among all the transmitters 10-1 to 10-N are used, but in a case where the number of the transmitters 10 is large or the like, the frequency hopping patterns that simultaneously use the same subband in some time period may be used. Moreover, the transmitters 10 and the receivers 20 do not necessarily have to correspond on a one-to-one basis, and one of the receivers 20 may correspond to a plurality of the transmitters 10. In this case, the receiver 20 may receive the signals by simultaneously using the frequency hopping patterns of the plurality of the transmitters 10, or may receive the signals by using the different frequency hopping patterns in a time division manner such as using the frequency hopping pattern of the transmitter 10-1 in a certain time period and using the frequency hopping pattern of the transmitter 10-2 in another time period.

As described above, according to the present embodiment, in the sensing system 30a, the plurality of the transmitters 10-1 to 10-N simultaneously transmitting the high frequency signals generates the carrier signals in the different subbands or in the different frequency hopping patterns at the same time among the plurality of the transmitters 10-1 to 10-N. As a result, the sensing system 30a can obtain an effect similar to that of the second embodiment.

### Fourth Embodiment

A fourth embodiment will describe a case where the principle of synthetic aperture radar (hereinafter referred to as SAR) is applied to reduce the number of antenna elements of an array antenna, that is, the transmitting array 17 and the receiving array 21. Note that the sensing system 30, the transmitter 10, and the receiver 20 of the fourth embodiment have configurations similar to the configurations of the sensing system 30, the transmitter 10, and the receiver 20 of the first embodiment.

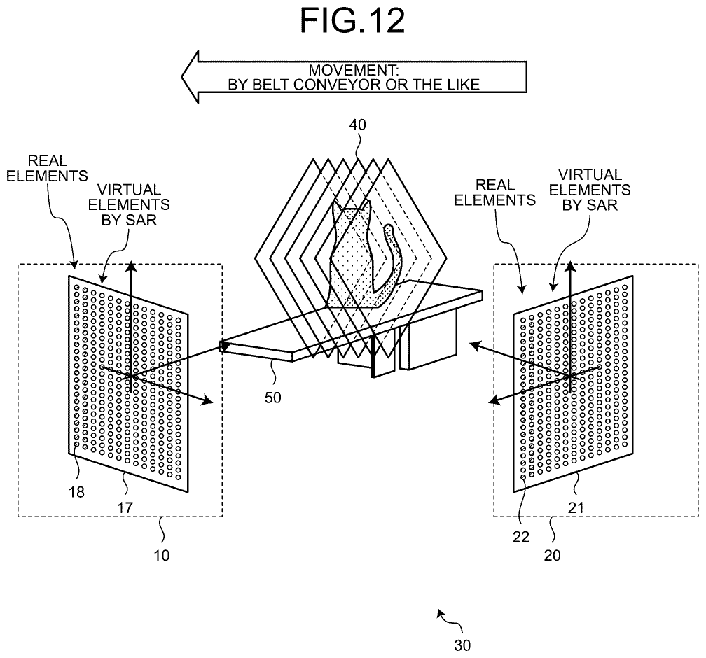

FIG. 12 is a diagram illustrating a general idea of measurement intended to be performed by the sensing system 30 according to the fourth embodiment. Even in the case as illustrated in FIG. 12, the MIMO channel reproduction unit 26 of the receiver 20 eventually generates the channel information of N_{T}×N_{R}×N_{F}×N_{B} elements. However, in the fourth embodiment, the number N_{T} of the transmitting antenna elements 18 of the transmitting array 17 and the number N_{R} of the receiving antenna elements 22 of the receiving array 21 are numbers including virtual antenna elements, and the number of real antenna elements, that is, the number of antenna elements that simultaneously transmit or receive radar signals is set to be smaller than N_{T} and N_{R}. FIG. 12 illustrates the example where, in the transmitting array 17 and the receiving array 21, two columns of filled antenna elements are the real antenna elements, and the other outlined antenna elements are the virtual antenna elements. In the fourth embodiment, it is assumed that the measurement target 40 moves under a condition in which the speed and direction are known, the condition being, for example, that the measurement target 40 is placed on a belt conveyor 50 or walks on a predetermined path.

The operation of the sensing system 30 will be described. The operation of the transmitter 10 is similar to the operation of the transmitter 10 in the first embodiment. The transmitter 10 performs generation and encoding of the radar signals, generation of the high frequency signals, and the like by the synchronization unit 11 controlling the transmission timing, and transmits the high frequency signals from the transmitting antenna elements 18 that are the real elements in the transmitting array 17. In the receiver 20, the signal conversion unit 23, the detection unit 24, the correlation processing unit 25, and the like perform processing similar to that in the first embodiment, and the MIMO channel information corresponding to the positions of the real elements in the transmitting array 17 and the receiving array 21 can be obtained.

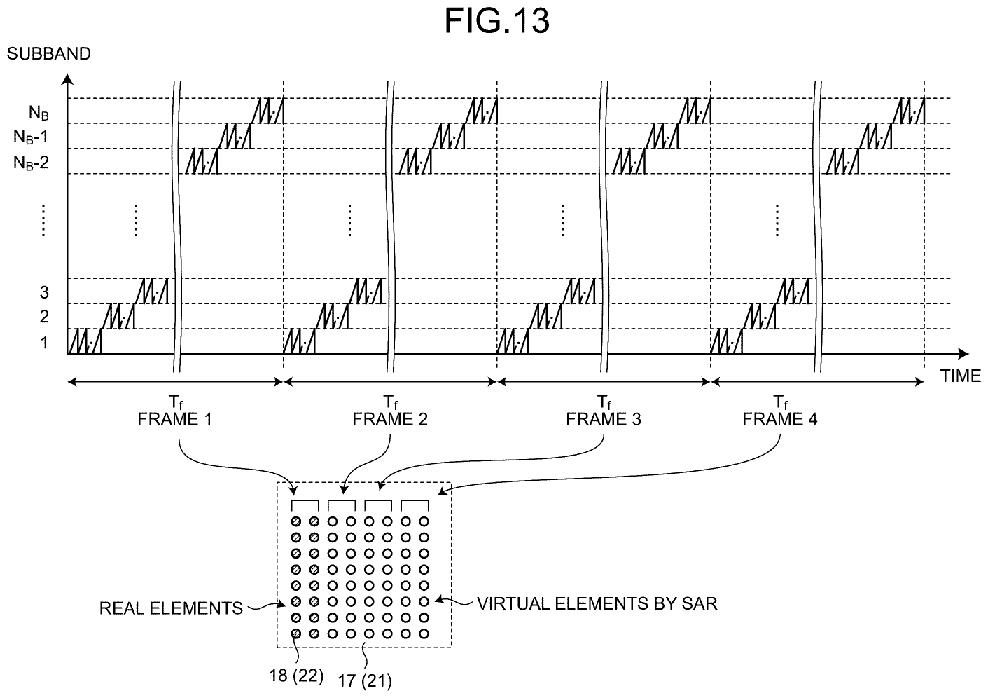

FIG. 13 is a graph illustrating an example of the high frequency signals transmitted from the transmitter 10 according to the fourth embodiment. The SAR can form a virtual large-scale array antenna by using the movement of the measurement target 40. As illustrated in FIG. 13, first, the transmitter 10 uses the transmitting antenna elements 18 as the real elements in the transmitting array 17 to transmit the high frequency signals of all the subbands in the period of frame 1. The receiver 20 uses the receiving antenna elements 22 as the real elements in the receiving array 21 to obtain the MIMO channel information based on the positions of the real elements in the transmitting array 17 and the receiving array 21. Next, the transmitter 10 uses the transmitting antenna elements 18 as the real elements in the transmitting array 17 to transmit the high frequency signals of all the subbands in the period of frame 2. The receiver 20 uses the receiving antenna elements 22 as the real elements in the receiving array 21 to obtain the MIMO channel information based on the positions of the real elements in the transmitting array 17 and the receiving array 21. At this time, the measurement target 40 is on the move so that, virtually, the sensing system 30 can obtain the MIMO channel information equivalent to that measured while shifting the positions of the transmitting antenna elements 18 and the positions of the receiving antenna elements 22.

How the positions of the transmitting antenna elements 18 and the positions of the receiving antenna elements 22 are shifted depends on the positional relationship among the transmitting array 17, the receiving array 21, the measurement target 40, and the like. Therefore, the sensing system 30 transmits and receives the high frequency signals in frame 2 to be able to obtain the MIMO channel information for the positions of virtual elements shifted from the real elements. The sensing system 30 can obtain the MIMO channel information for the positions of the virtual elements in frame 3 and frame 4 as time passes, that is, as the measurement target 40 moves, and can eventually obtain the MIMO channel information of N_{T}×N_{R}×N_{F}×N_{B} elements by the MIMO channel reproduction unit 26. Note that, in the receiver 20, the operations of the layer clipping unit 27 and the focus correction unit 28 following the MIMO channel reproduction unit 26 are similar to the operations of the layer clipping unit 27 and the focus correction unit 28 of the first embodiment. Thus, even in the case where the number of real elements of the transmitting antenna elements 18 in the transmitting array 17 of the transmitter 10 is smaller than N_{T} and the number of real elements of the receiving antenna elements 22 in the receiving array 21 of the receiver 20 is smaller than N_{R}, the receiver 20 can output an image on the basis of the MIMO channel information of N_{T}×N_{R}×N_{F}×N_{B} elements as in the first embodiment.

Note that the case has been described in which the measurement target 40 moves with respect to the transmitting antenna elements 18 of the transmitting array 17 of the transmitter 10 and the receiving antenna elements 22 of the receiving array 21 of the receiver 20, but the present disclosure is not limited thereto. For example, the measurement target 40 may be at a standstill, and the transmitter 10 and the receiver 20 may move. Regarding the transmitter 10 and the receiver 20, it is not necessary that the entire transmitter 10 moves and the entire receiver 20 moves, and it is sufficient that the transmitting array 17 of the transmitter 10 moves relative to the measurement target 40 and that the receiving array 21 of the receiver 20 moves relative to the measurement target 40. As described above, in the sensing system 30, when the plurality of the transmitting antenna elements 18 of the transmitter 10 and the plurality of the receiving antenna elements 22 of the receiver 20 move or the measurement target 40 moves, the positions of the plurality of the transmitting antenna elements 18 of the transmitter 10 and the plurality of the receiving antenna elements 22 of the receiver 20 with respect to the measurement target 40 are changed. The transmitter 10 repeatedly transmits the high frequency signals using the entire frequency band available. The MIMO channel reproduction unit 26 of the receiver 20 generates the channel information based on a larger number of the transmitting antenna elements 18 than that actually included in the transmitter 10 and a larger number of the receiving antenna elements 22 than that actually included in the receiver 20.

As described above, according to the present embodiment, the sensing system 30 uses the movement of the measurement target 40 or the movements of the plurality of the transmitting antenna elements 18 of the transmitter 10 and the plurality of the receiving antenna elements 22 of the receiver 20, thereby being capable of performing high-resolution measurement with a smaller number of antenna elements and performing high-resolution imaging.

### Fifth Embodiment

A fifth embodiment will describe specific operations of the layer clipping unit 27 and the focus correction unit 28 of the receiver 20.

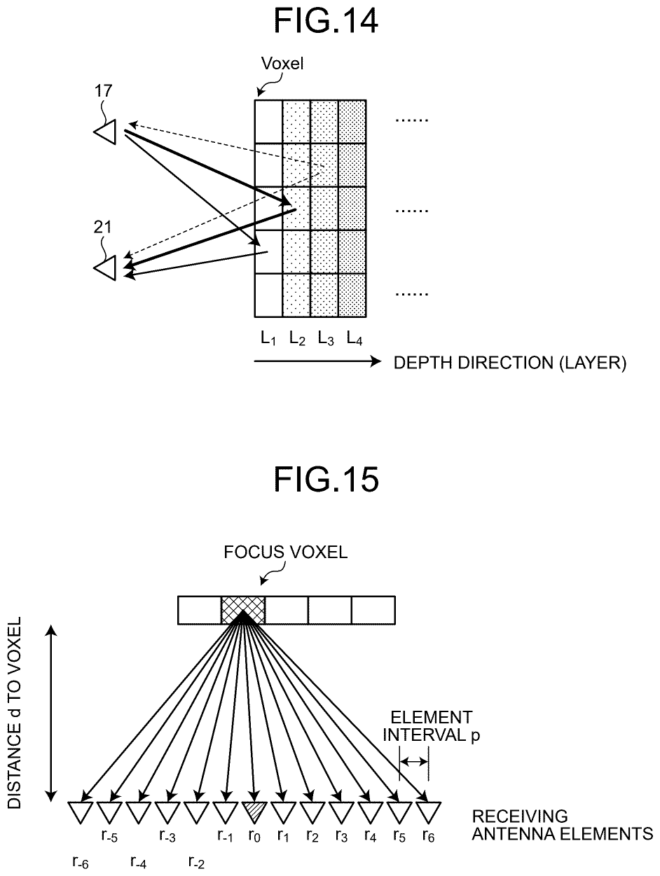

FIG. 14 is a diagram illustrating a concept of an operation of the layer clipping unit 27 of the receiver 20 according to the fifth embodiment. When the space of the measurement target 40 is considered by dividing the space into small regions, the small regions are called voxels. For example, in a case where the transmitting array 17 of the transmitter 10 and the receiving array 21 of the receiver 20 are oriented in the same direction, when the voxels as measurement points that are at the same distance from the array surface of the transmitting array 17 or the receiving array 21 are collected, a curved surface is formed. When this curved surface is considered as a layer, the closer the layer is to the front, the shorter the path of the transmitting antenna element 18→the reflection point→the receiving antenna element 22, whereby a propagation delay time is reduced. The layer clipping unit 27 can use such property to perform layer clipping by extracting only a signal within a specific delay time range from the received signals measured. FIG. 14 illustrates an example in which the layer clipping unit 27 clips out the layers that are divided into four layers of L₁, L₂, L₃, and L₄ from the front.

FIG. 15 is a diagram illustrating a concept of an operation of the focus correction unit 28 of the receiver 20 according to the fifth embodiment. FIG. 15 focuses on a specific voxel and illustrates how the radar signal reflected by a certain voxel is received by the receiving antenna elements 22 of the receiving array 21. In a case where the receiving antenna elements 22 are disposed at element intervals “p” with the receiving antenna element 22 facing the front of the voxel being a zeroth receiving antenna element 22, in order to focus on this voxel, a k-th receiving antenna element 22 requires a phase rotation ξₖ expressed by the following expression.

ξₖ=−2π×(√(d²+(kp)²))/λ (1)

In Expression (1), “d” is a distance from the array surface to the layer, and “λ” is a wavelength of the radar signal. Moreover, “√(d²+(kp)²)” represents a square root of “(d²+(kp)²)”. In a case where the receiving array 21 is a two-dimensional array antenna, the receiving antenna elements 22 are disposed on a plane so that the focus correction unit 28 calculates the amount of phase rotation in consideration of two dimensions. Since the amount of phase rotation depends on the distance “d”, that is, varies depending on the layer, the focus correction unit 28 performs focus correction processing for each layer and outputs an image. Note that either one of the layer clipping processing of the layer clipping unit 27 and the focus correction processing of the focus correction unit 28 may be applied first, and the processings are performed in no particular order.

Note that the layer clipping processing of the layer clipping unit 27 is necessary in a case where signals transmitted in the same direction or signals arriving from the same direction include reflection point information of a plurality of distances. Therefore, in a case where the measurement target 40 does not transmit electromagnetic waves so that the reflection point is only on the surface of the target, the reflected wave from a specific direction is limited to one point, whereby the layer clipping processing of the layer clipping unit 27 can be omitted.

The sensing system according to the present disclosure can improve the resolution at low cost while using the high frequency signal when measuring the measurement target that is close by.

The configurations illustrated in the above embodiments each merely illustrate an example so that another known technique can be combined, the embodiments can be combined together, or the configurations can be partially omitted and/or modified without departing from the scope of the present disclosure.

What is claimed is:

1. A sensing system comprising:
a transmitter that includes a plurality of transmitting antenna elements to: control timings of generation of a radar signal, generation of a code for a receiver to separate high frequency signals transmitted from the plurality of the transmitting antenna elements into the high frequency signals transmitted from individual ones of the transmitting antenna elements, and generation of a carrier signal to divide a frequency band available into a plurality of subbands and periodically switch the subbands used for the high frequency signals transmitted from the plurality of the transmitting antenna elements so that an entire range of the frequency band is used; multiply the radar signal and the code for each of the plurality of the transmitting antenna elements; generate the high frequency signal having a bandwidth of the subband using the radar signal multiplied by the code and the carrier signal; and transmit the high frequency signal from each of the plurality of the transmitting antenna elements; and
a receiver that includes a plurality of receiving antenna elements to: receive the high frequency signals transmitted from the transmitter and reflected or scattered by a measurement target; generate channel information indicating a state of a channel between the transmitter and the receiver using the carrier signal, the radar signal, and the code; specify a position of the measurement target using the channel information; and generate an image of the measurement target by performing focus correction on the measurement target.

2. The sensing system according to claim 1, wherein
the receiver generates the channel information, the number of which is equal to a number obtained by multiplying the number of the plurality of the transmitting antenna elements included in the transmitter, the number of the plurality of the receiving antenna elements included in the receiver, the number of the subbands, and the number of frequency bins obtained when the bandwidth of the subband is divided into a plurality of the frequency bins.

3. The sensing system according to claim 1, wherein
the transmitter generates the code such that a chip period of the code is an integer multiple of a period of the radar signal.

4. The sensing system according to claim 1, wherein
the receiver specifies the position of the measurement target by extracting, from the channel information, reflection point information of a layer corresponding to a distance in a depth direction of the measurement target as viewed from the plurality of the receiving antenna elements, and performs, as the focus correction on the measurement target, focus correction corresponding to a position of the layer on the reflection point information extracted.

5. The sensing system according to claim 1, comprising
a plurality of the transmitters and a plurality of the receivers, wherein
the plurality of the transmitters operates in synchronization with each other in generation of the radar signal, generation of the code, and generation of the carrier signal, and generates the code having a low correlation among the plurality of the transmitters, and
the plurality of the receivers each performs correlation processing by using the code used in a corresponding one of the transmitters.

6. The sensing system according to claim 5, wherein
the plurality of the transmitters generates an orthogonal code or a quasi-orthogonal code as the code having the low correlation among the plurality of the transmitters.

7. The sensing system according to claim 5, wherein
the plurality of the transmitters generates the carrier signal in the subbands different from each other at the same time among the plurality of the transmitters.

8. The sensing system according to claim 5, wherein
the plurality of the transmitters generates the carrier signal in frequency hopping patterns different from each other among the plurality of the transmitters.

9. The sensing system according to claim 1, wherein
while positions of the plurality of the transmitting antenna elements and the plurality of the receiving antenna elements with respect to the measurement target are changed by movements of the plurality of the transmitting antenna elements and the plurality of the receiving antenna elements or a movement of the measurement target,
the transmitter repeatedly transmits the high frequency signals using the entire range of the frequency band available, and
the receiver generates the channel information based on a larger number of the transmitting antenna elements than that actually included in the transmitter and a larger number of the receiving antenna elements than that actually included in the receiver.

10. A receiver that includes a plurality of receiving antenna elements and receives reflected waves or scattered waves of high frequency signals that are transmitted from a transmitter including a plurality of transmitting antenna elements and are reflected or scattered by a measurement target, the receiver comprising:
signal conversion circuitry to convert the reflected waves or the scattered waves of the high frequency signals received by the plurality of the receiving antenna elements into received signals in a frequency band of a radar signal, which is used for generation of the high frequency signal by the transmitter, by using a carrier signal used for generation of the high frequency signal by the transmitter;
detection circuitry to detect the received signals using the radar signal and obtain received information that is the reflected waves or the scattered waves of the high frequency signals received by the receiving antenna elements and includes the high frequency signals transmitted from the plurality of the transmitting antenna elements;
correlation processing circuitry to perform correlation processing on the received information by using a code used when the radar signal is encoded by the transmitter, and separate the received signals into the individual signals of the transmitting antenna elements transmitted from the transmitter for each of the receiving antenna elements;
channel reproduction circuitry to generate channel information indicating a state of a channel between the transmitter and the receiver using the signals separated;
layer clipping circuitry to specify a position of the measurement target using the channel information; and
focus correction circuitry to generate an image of the measurement target by performing focus correction on the measurement target after the position of the measurement target is specified.

11. The receiver according to claim 10, wherein
the transmitter transmits the high frequency signals by dividing a frequency band available into a plurality of subbands and periodically switching the subbands used for the high frequency signals transmitted from the plurality of the transmitting antenna elements so that an entire range of the frequency band is used, and
the channel reproduction circuitry generates the channel information, the number of which is equal to a number obtained by multiplying the number of the plurality of the transmitting antenna elements included in the transmitter, the number of the plurality of the receiving antenna elements included in the receiver, the number of the subbands, and the number of frequency bins obtained when a bandwidth of the subband is divided into a plurality of the frequency bins.

12. The receiver according to claim 10, wherein
the layer clipping circuitry specifies the position of the measurement target by extracting, from the channel information, reflection point information of a layer corresponding to a distance in a depth direction of the measurement target as viewed from the plurality of the receiving antenna elements, and
the focus correction circuitry performs, as the focus correction on the measurement target, focus correction corresponding to a position of the layer on the reflection point information extracted.

13. The receiver according to claim 10, wherein
a plurality of the transmitters and a plurality of the receivers constitute a sensing system, the plurality of the transmitters generating the code having a low correlation among the plurality of the transmitters, and
the correlation processing circuitry of the plurality of the receivers performs correlation processing by using the code used in a corresponding one of the transmitters.

14. The receiver according to claim 10, wherein
the high frequency signals are repeatedly transmitted using an entire range of a frequency band available for use by the transmitter while positions of the plurality of the transmitting antenna elements and the plurality of the receiving antenna elements with respect to the measurement target are changed by movements of the plurality of the transmitting antenna elements and the plurality of the receiving antenna elements or a movement of the measurement target, and
the channel reproduction circuitry generates the channel information based on a larger number of the transmitting antenna elements than that actually included in the transmitter and a larger number of the receiving antenna elements than that actually included in the receiver.

15. A control circuit for controlling a sensing system that includes a transmitter including a plurality of transmitting antenna elements and a receiver including a plurality of receiving antenna elements, the control circuit causing the sensing system to execute:
controlling timings of generation of a radar signal, generation of a code for the receiver to separate high frequency signals transmitted from the plurality of the transmitting antenna elements into the high frequency signals transmitted from individual ones of the transmitting antenna elements, and generation of a carrier signal to divide a frequency band available into a plurality of subbands and periodically switch the subbands used for the high frequency signals transmitted from the plurality of the transmitting antenna elements so that an entire range of the frequency band is used; multiplying the radar signal and the code for each of the plurality of the transmitting antenna elements; generating the high frequency signal having a bandwidth of the subband using the radar signal multiplied by the code and the carrier signal; transmitting the high frequency signal from each of the plurality of the transmitting antenna elements;
receiving the high frequency signals transmitted from the transmitter and reflected or scattered by a measurement target; generating channel information indicating a state of a channel between the transmitter and the receiver using the carrier signal, the radar signal, and the code; specifying a position of the measurement target using the channel information; and generating an image of the measurement target by performing focus correction on the measurement target.

16. A control circuit for controlling a transmitter including a plurality of transmitting antenna elements, the control circuit causing the transmitter to execute:
generating a radar signal that is a broadband signal;
generating a code for a receiver to separate high frequency signals transmitted from the plurality of the transmitting antenna elements into the high frequency signals transmitted from individual ones of the transmitting antenna elements;
multiplying the radar signal by the code for each of the plurality of the transmitting antenna elements;
generating a carrier signal to divide a frequency band available for use by the transmitter into a plurality of subbands and periodically switch the subbands used for the high frequency signals transmitted from the plurality of the transmitting antenna elements so that an entire range of the frequency band is used;
generating the high frequency signal having a bandwidth of the subband using the radar signal multiplied by the code and the carrier signal, and transmitting the high frequency signal from each of the plurality of the transmitting antenna elements; and
controlling timings of generation of the radar signal, generation of the code, and generation of the carrier signal.

17. A control circuit for controlling a receiver that includes a plurality of receiving antenna elements and receives reflected waves or scattered waves of high frequency signals that are transmitted from a transmitter including a plurality of transmitting antenna elements and are reflected or scattered by a measurement target, the control circuit causing the receiver to execute:
converting the reflected waves or the scattered waves of the high frequency signals received by the plurality of the receiving antenna elements into received signals in a frequency band of a radar signal, which is used for generation of the high frequency signal by the transmitter, by using a carrier signal used for generation of the high frequency signal by the transmitter;
detecting the received signals using the radar signal and obtaining received information that is the reflected waves or the scattered waves of the high frequency signals received by the receiving antenna elements and includes the high frequency signals transmitted from the plurality of the transmitting antenna elements;
correlation processing on the received information by using a code used when the radar signal is encoded by the transmitter, and separating the received signals into the individual signals of the transmitting antenna elements transmitted from the transmitter for each of the receiving antenna elements;
generating channel information indicating a state of a channel between the transmitter and the receiver using the signals separated;
specifying a position of the measurement target using the channel information; and
generating an image of the measurement target by performing focus correction on the measurement target after the position of the measurement target is specified.

18. A sensing method comprising:
performing: controlling timings of generation of a radar signal, generation of a code for a receiver including a plurality of receiving antenna elements to separate high frequency signals transmitted from a plurality of transmitting antenna elements of a transmitter into the high frequency signals transmitted from individual ones of the transmitting antenna elements, and generation of a carrier signal to divide a frequency band available into a plurality of subbands and periodically switch the subbands used for the high frequency signals transmitted from the plurality of the transmitting antenna elements so that an entire range of the frequency band is used; multiplying the radar signal and the code for each of the plurality of the transmitting antenna elements; generating the high frequency signal having a bandwidth of the subband using the radar signal multiplied by the code and the carrier signal; and transmitting the high frequency signal from each of the plurality of the transmitting antenna elements; and
performing: receiving the high frequency signals transmitted from the transmitter and reflected or scattered by a measurement target; generating channel information indicating a state of a channel between the transmitter and the receiver using the carrier signal, the radar signal, and the code; specifying a position of the measurement target using the channel information; and generating an image of the measurement target by performing focus correction on the measurement target.

19. A transmission method by a transmitter including a plurality of transmitting antenna elements, the transmission method comprising:
generating a radar signal that is a broadband signal;
generating a code for a receiver to separate high frequency signals transmitted from the plurality of the transmitting antenna elements into the high frequency signals transmitted from individual ones of the transmitting antenna elements;
multiplying the radar signal by the code for each of the plurality of the transmitting antenna elements;
generating a carrier signal to divide a frequency band available for use by the transmitter into a plurality of subbands and periodically switch the subbands used for the high frequency signals transmitted from the plurality of the transmitting antenna elements so that an entire range of the frequency band is used;
generating the high frequency signal having a bandwidth of the subband using the radar signal multiplied by the code and the carrier signal, and causing the high frequency signal to be transmitted from each of the plurality of the transmitting antenna elements; and
controlling timings of generation of the radar signal, generation of the code, and generation of the carrier signal.

20. A reception method by a receiver that includes a plurality of receiving antenna elements and receives reflected waves or scattered waves of high frequency signals that are transmitted from a transmitter including a plurality of transmitting antenna elements and are reflected or scattered by a measurement target, the reception method comprising:
converting the reflected waves or the scattered waves of the high frequency signals received by the plurality of the receiving antenna elements into received signals in a frequency band of a radar signal, which is used for generation of the high frequency signal by the transmitter, by using a carrier signal used for generation of the high frequency signal by the transmitter;
detecting the received signals using the radar signal and obtaining received information that is the reflected waves or the scattered waves of the high frequency signals received by the receiving antenna elements and includes the high frequency signals transmitted from the plurality of the transmitting antenna elements;
performing correlation processing on the received information by using a code used when the radar signal is encoded by the transmitter, and separating the received signals into the individual signals of the transmitting antenna elements transmitted from the transmitter for each of the receiving antenna elements;
generating channel information indicating a state of a channel between the transmitter and the receiver using the signals separated;
specifying a position of the measurement target using the channel information; and
generating an image of the measurement target by performing focus correction on the measurement target after the position of the measurement target is specified.
